(19) United States
(12) Patent Application Publication
(10) Pub. No.: US 2018/0011005 A1
(43) Pub. Date: Jan. 11, 2018

(54) APPARATUS FOR INLINE TRACE ANALYSIS OF A LIQUID

(71) Applicant: MICRO-EPSILON Messtechnik GmbH & Co. KG, Ortenburg (DE)

(72) Inventors: Gerhard Kirschner, Passau (DE); Thomas Wisspeintner, Ortenburg (DE); Martin Sczepan, Dresden (DE); Helmut Hummel, Schierling (DE); Alfred Lechner, Lappersdorf (DE); Michael Bauhuber, Stephansposching (DE)

(21) Appl. No.: 15/542,574

(22) PCT Filed: Jan. 7, 2016
(86) PCT No.: PCT/DE2016/200000

§ 371 Date: Jul. 10, 2017

(30) Foreign Application Priority Data
Jan. 8, 2015 (DE) 10 2015 200 115.6
Sep. 21, 2015 (DE) 10 2015 218 095.6

(51) Int. Cl. G01N 21/05; G01N 1/20; B01L 3/00; G01N 15/14; G01N 1/38

(52) U.S. Cl. CPC G01N 21/05; G01N 15/1429; G01N 1/38; B01L 3/502715; B01L 3/502784; B01L 3/50273; G01N 1/2042

(57) ABSTRACT

The invention relates to an apparatus for the inline trace analysis of a liquid, preferably of an aqueous process solution, comprising: a housing (1); a micro-channel (2) through which the liquid to be examined is allowed to flow and into which light of a light source (3) is coupled; a detector (4) for light emerging from the micro-channel (2); and a user interface (5) for monitoring and/or operating the apparatus. The micro-channel (2), the detector (4) and/or the user interface (5) are arranged in the housing (1) and/or are integrated into the housing (1), and the housing (1) has a connection (6) for feeding the liquid in the micro-channel (2) and a connection (7) for power supply of the apparatus.

### CROSS REFERENCE TO RELATED APPLICATIONS

This application is a national stage application, filed under 35 U.S.C. §371, of International Application No. PCT/DE2016/200000, filed Jan. 7, 2016, which claims priority to German Application No. 10 2015 200 115.6, filed Jan. 8, 2015, and German Application No. 10 2015 218 095.6 filed Sep. 21, 2015, the contents of all of which as are hereby incorporated by reference in their entirety.

### BACKGROUND

### Technical Field

The invention relates to an apparatus for inline trace analysis of a fluid, preferably an aqueous process solution.

Apparatuses for trace analysis of a fluid and, in particular, an aqueous process solution are very important, for example, in the semiconductor industry, because the slightest contamination of process solutions can make complete batches unfit for use as early as in production. In order to increase productivity and to decrease production losses, continuous monitoring of the purity of the process media is essential.

Furthermore, drinking water and wastewater analysis also constitutes a broad market for the inventive apparatus in the future. Owing to the ever-decreasing maximum allowable pollutant levels in wastewaters, described in the EU Water Framework Directive, it is necessary in many areas to detect even the slightest contamination.

Other markets that may be considered include the food industry as well as medical technology. In this case, too, detection of impurities in process media is very important and increases the quality assurance of the products enormously.

### Description of Related Art

An apparatus for trace analysis of a fluid is already known from the published document EP 2 486 388 B1. The known apparatus comprises a microchannel, designed as a liquid optical waveguide, on a substrate in the form of a silicon wafer. A fluid to be analyzed is allowed to flow through this microchannel. Furthermore, light from a light source is coupled into the microchannel; and the light emerging from the microchannel is analyzed with a detector. In this connection a number of analytic methods are used: for example, spectroscopic methods, which are based on absorption, transmission, fluorescence and Raman scattering. Using the known apparatus, it is possible to detect substances dissolved in fluids in the sub ppb range.

The design of the known apparatus, described in EP 2 486 388 B1, makes it possible to fulfill the objective of a miniaturized apparatus, which, nevertheless, provides a long light path inside the fluid, to be analyzed, in the microchannel.

### BRIEF SUMMARY

At this point the object of the present invention is to embody and further develop an apparatus of the aforementioned type in such a way that a safe and easy handling of the apparatus as an inline measuring device is made possible with structurally simple means.

The aforementioned engineering object is achieved in accordance with the invention by means of an apparatus exhibiting the features disclosed in the provided claims, according to which the apparatus comprises a housing; a microchannel, through which the fluid to be analyzed is allowed to flow and into which light of a light source is coupled; a detector for light emerging from the microchannel; and a user interface for monitoring and/or operating the apparatus, wherein the microchannel, the detector and/or the user interface is/are arranged in the housing and/or is/are integrated into the housing, and wherein the housing has a port for feeding the fluid into the microchannel and a terminal for supplying power to the apparatus.

At this point it should be noted that the housing is a housing in the broadest sense. Hence, the housing can be formed by just a carrier plate or a frame. Even a closed embodiment of the housing is encompassed by the general term “housing”.

It has been found in accordance with the invention that it is possible to arrange the components, which are relevant for the apparatus to work, in a housing in such a way that a particularly easy handling of the apparatus, in particular, as an inline measuring device or as a portable measuring device, is made possible in a structurally simple way. In the specific case both the microchannel and the detector are arranged in a housing or are integrated into the housing. In this respect the housing has in further accordance with the invention a port for feeding the fluid to be analyzed into the microchannel. Furthermore, for a reliable supply of power to the apparatus, the housing has a terminal to supply power to the apparatus.

Furthermore, with respect to the easy handling of the apparatus as an inline measuring device, this objective is fulfilled with a user interface, which is arranged in the housing or is integrated into the housing. This user interface is used to monitor and/or operate the apparatus.

Consequently the inventive apparatus permits easy handling as an inline measuring instrument with structurally simple means.

With respect to particularly easy handling of the apparatus, the light source may be disposed in the housing. In this case a separate supply of light from outside the housing into the microchannel is not required. As an alternative and with respect to a particularly high flexibility of the light source that is used, the housing may comprise a port for feeding the light of the light source into the microchannel. Such a port allows the flexible use of different light sources, and the selected light source has only to be coupled to the port from outside the housing. Various types may be considered as the light sources. An LED light source, which is associated with a long life and a low thermal output, can be used in a particularly practical way. In this context an LED light source also lends itself quite well to being built into the housing without having to be concerned about the function of the apparatus being degraded by a high thermal output. Another advantage of an LED light source is that the spectral distribution of light can be controlled to some extent. As a result, the spectrum that is used can be adjusted to the substance to be analyzed. However, it is also possible to use, depending on the application, halogen light sources, tunable laser light sources or other light sources.

With respect to a particularly high throughput or continuous measurement of a fluid to be analyzed, the housing may include a port to discharge the fluid from the microchannel. With such an embodiment it is not only possible to feed the fluid to be analyzed into the housing and, thus, from the outside into the microchannel, but also, after an analysis, to discharge said fluid from the housing. In an alternative embodiment a collecting container for fluid emerging from the microchannel may be disposed in the housing. In this case the fluid to be analyzed is passed, after the analysis, into the collecting container, which can be emptied in a suitable way on reaching a specifiable filling level. In an alternative embodiment the collecting container may be arranged in the housing in a manner allowing removal, so that it can be taken out of the housing in order to empty said collecting container. Furthermore, this type of removability also allows the collecting container to be easily cleaned in the removed state.

With respect to ensuring a particularly reliable analysis and measurement with the apparatus in accordance with the invention, this objective may be fulfilled with a reference channel, which may be provided, for example, in the form of an optical waveguide, which can extend virtually parallel to the microchannel. Then in one measurement method a reference spectrum, on the one hand, and a measured spectrum, on the other hand, can be compared with each other, in order to fulfill the objective of a reliable measurement result. In order to match the light intensities of the measurement channel with the reference channel, the reference channel can be assigned an attenuator.

Furthermore, if there is a reference channel, then the reference channel may be assigned a switch-over device for the light, so that either the light, passed through the microchannel, or the light, passed through the reference channel, can be measured in the detector. The switch-over device could be implemented as a stopper or shutter. Furthermore, the switch-over device can be arranged, for example, directly in front of a spectrometer or detector. The switch-over device permits a simple embodiment of the detector in the form of, for example, a line detector, since in all cases only light from one channel is to be detected. For an optionally necessary dark adjustment of the detector, the switch-over device can switch off both the measurement channel and the reference channel, so that no light falls on the detector. As a result, the dark current of the detector can be determined; and the dark adjustment can be carried out. In other words, in order to measure the dark field, both the light, passed through the microchannel, and the light, passed through the reference channel, can be blocked off from the detector or in front of the detector.

The apparatus of the invention is used to detect minute traces of substances in a fluid. Frequently the substance to be detected cannot be detected directly, but rather only after completion of a detection reaction. For this purpose a complexing agent is added to the fluid to be analyzed, i.e. the analyte; and this complexing agent triggers the detection reaction. The analyte and the complexing agent may be combined in a mixer. In this case the mixer may be a structured component, where an efficient and thorough mixing takes place. In a particularly simple manner, the mixer is simply a coupling point, where the two fluids meet. The product of the detection reaction can be identified, for example, by means of an absorption measurement. With respect to a particularly safe handling of the apparatus and to carrying out the measurement, it is possible to use safety valves that ensure the necessary safety in operating and handling the apparatus when feeding in the fluid, the analyte or a complexing agent. When the apparatus is in operating states that are inadmissible or undesired, the safety valves can be used to suppress the supply and/or the discharge of the fluid and/or an analyte and/or a complexing agent. Inadmissible or undesired operating states of the apparatus may be, for example, exceeding a specifiable pressure level, the failure of systemically relevant components or the escape of fluids, i.e., leakage. Furthermore, the safety valves can prevent the fluids from flowing back into the higher level system.

In the specific case, in a preferred embodiment of the apparatus a supply line for supplying and/or a discharge line for discharging the fluid and/or an analyte and/or a complexing agent and/or the microchannel may be assigned a safety valve when a specifiable pressure level is exceeded in the supply line, the discharge line or the microchannel. In the final end, a safety valve may be used in all cases where a fluid, an analyte or a complexing is supplied or discharged.

Furthermore, with respect to a particularly high level of safety when the apparatus is running, a humidity sensor or leak sensor can be disposed in the housing. Such a sensor can respond to an unwanted leakage of fluid and can provide a suitable signal and, if desired, transmit said signal to an alarm device. For example, a humidity sensor or leak sensor may be disposed in a drip tray for fluids, and said drip tray can be disposed at a suitable point in the housing, preferably below supply lines or discharge lines or below the microchannel.

The signal of the humidity or leak sensor can be used to actuate the safety valves and to suppress the supply and/or to discharge the fluid and/or the analyte and/or the complexing agent. In a further advantageous manner the humidity sensor or the leak sensor may be assigned a switch-off device for the apparatus and/or a pump or a piezoelectric diaphragm pump. Such pumps or piezoelectric diaphragm pumps can be used for conveying the fluid, the analyte or a complexing agent in a suitable way.

For a reliable operation of the apparatus and for a reliable measurement it is important to ensure that there are no air bubbles in the supply lines or in the microchannel or that no bubbles are generated in the supply lines or in the microchannel. For this purpose a supply line for supplying the fluid and/or an analyte and/or a complexing agent and/or the microchannel may be assigned a degassing device. Such a degassing device may have, for example, a semi-permeable diaphragm and a vacuum pump. In this case not only air bubbles, but also gases, such as oxygen, which are dissolved, for example, in the fluid, have to be removed as much as possible, in order to ensure a reliable measurement.

With respect to a reliable supply of fluid and/or a reliable passage of the fluid, an analyte or a complexing agent, a supply line for supplying and/or a discharge line for discharging the fluid and/or an analyte and/or a complexing agent and/or the microchannel can be assigned a flow measuring device. Such a flow measuring device can be used preferably for open or closed loop control of a flow rate. In this respect the flow measuring device can be coupled with suitable pumps, in order to influence the flow rate. As a result, in particular, the flow rate of an analyte and/or a complexing agent can be specified precisely; and suitable mixing ratios can be carried out exactly.

In order to supply or convey liquid components reliably, a supply line for supplying and/or a discharge line for discharging the fluid and/or an analyte and/or a complexing agent and/or the micro channel can be assigned a suitable pump, in particular, a piezoelectric diaphragm pump. In this way a reliable guide of the necessary and suitable liquid components in the apparatus is ensured.

With respect to operating the apparatus reliably and easily, the apparatus may have a flushing device for a supply line for supplying and/or a discharge line for discharging the fluid and/or an analyte and/or a complexing agent and/or for the microchannel. In particular, after a long continuous inline operation of the apparatus, it may be necessary to flush the fluid lines of the apparatus. This objective can be fulfilled in a simple manner by means of such a flushing device.

With respect to a reliable operation of the apparatus and a possible multi-channel design, the fluid-carrying components, i.e., the supply lines, the discharge lines, the pumps, the safety valves, the degassing devices, the microchannel, etc., can be mounted on a drip tray. The drip tray is designed to catch the fluid in case of leaks and to feed said fluids to a humidity or leak sensor. Mounting all of the components on the drip tray allows this unit, also called the fluidic module, to be easily swapped. One special advantage of the modular design is that several units can be installed in one housing, so that a multi-channel system is formed, in which a plurality of different fluids can be analyzed. For this purpose the optical components have multiple inputs and outputs, so that they can be used for multiple measurement channels.

In a particularly advantageous embodiment, only the switch-over device is equipped with more than two channels, for example, with four channels, of which one is used for the reference channel, while the other three are available for measurement channels. For a multi-channel embodiment only the fluidic module has to be arranged in duplicate, triplicate, or a plurality of times, while the spectrometer and the light source are present just once.

In order to ensure the total reflection, required for the measurements to be carried out, in the microchannel, the microchannel typically has a coating made of a suitable plastic, for example, Teflon®. However, this plastic coating is conducive to the growth of harmful bacteria and germs in the microchannel, so that the quality of the measurement is significantly affected. In addition to germ growth, an accumulation of gas bubbles, in particular, oxygen bubbles, in the microchannel leads to a degradation of the measurement. To kill or eliminate these bacteria and germs and to prevent gas bubbles, the microchannel can be assigned a UV irradiation device to radiate the ultraviolet light into the microchannel. In order to prevent the ultraviolet light from entering into the detector, which is downstream of the microchannel, and from affecting the measurement, the ultraviolet light can be radiated counter to the direction of measurement through the microchannel away from the detector. With respect to killing the bacteria and germs in a particularly reliable way, the UV irradiation device may be designed in such a way that it is possible to radiate the ultraviolet light into both ends of the microchannel. In this way the ultraviolet light can enter the microchannel from two sides in a reliable way. At this point a particularly effective light source for the ultraviolet light is a xenon flash tube. Since the flash tube is operated in pulsed mode, the total radiation power can be specifically adapted to kill bacteria and germs and/or to prevent gas bubbles. Owing to the pulsed operation the power loss, i.e., the waste heat, is reduced just as well in the housing. An additional advantage of the pulsed operation is the resulting possible synchronization with the detector, so that any effect on the measurement, for example, by stray light is further reduced.

An additional UV light source to kill bacteria and germs can be mounted in front of the microchannel. It is particularly advantageous to mount it on the foremost point of the apparatus, in order to prevent the growth of bacteria and germs as soon as possible or to kill already existing bacteria and germs or those that have been flushed in. The UV light source can be arranged directly behind the safety valve.

Instead of an irradiation by ultraviolet light, the pH of the fluids (the analyte or the complexing agent) flowing through the apparatus could also be adapted, so that the growth of germs is prevented, or already existing bacteria and germs are killed. The pH value may be adjusted in such a way that an acidic environment is generated, for example, with a pH=2. However, an alkaline, i.e., basic, environment would also be conceivable. Especially advantageous is the adjustment of the pH by way of the complexing agent.

With respect to a reliable and easy operation of the apparatus, a computer can be disposed in the housing, and said computer is designed preferably as a PC. With such a computer the entire apparatus can be controlled. In addition, an evaluation of the measurement results can be carried out with the computer. The computer can be implemented in an advantageous manner as a so-called “embedded” computer with a suitable interface, in order to allow, for example, integration into a network.

Also with respect to a particularly safe and easy handling of the apparatus, the housing may be designed in such a way that it can be arranged in a frame, preferably in a 19 inch frame. Such frames permit a secure arrangement of the housing when operating the apparatus and, as a result, good accessibility for an operator.

The inventive apparatus for inline trace analysis of a fluid fulfills the objective of a compact inline measuring unit that can be used in a particularly advantageous manner for a wide range of analytic applications. In such an analysis flow rates of a few μ1/min. through the microchannel are typical.

Furthermore, the apparatus in accordance with the invention fulfills the objective of an automated analyzing device for the continuous detection of, for example, metal ions in a sub ppb range. Impurities in very low concentrations in aqueous solutions can be detected spectrometrically by means of a preferably spiral-shaped microchannel having a large length of several meters. In this case the light is coupled into a channel, through which the analyte has been flushed, and is guided over as long a path as possible owing to total reflection, in order to achieve a measurable extinction even at very low ion concentrations.

### BRIEF DESCRIPTION OF THE FIGURES

There are a number of ways to embody and further develop the teaching of the present invention in an advantageous fashion. To this end, reference is made, on the one hand, to the dependent claims and, on the other hand, to the following explanation of a preferred embodiment of the invention with reference to the drawings. In conjunction with the explanation of the preferred exemplary embodiment of the invention with reference to the drawings, preferred embodiments and further developments of the teaching are also explained in general. In the drawings

FIG. 1 shows in schematic form a view of an exemplary embodiment of the inventive apparatus for inline trace analysis of a fluid; and

FIG. 2 shows in detail a subarea of the inventive apparatus for inline trace analysis of a fluid from FIG. 1.

### DETAILED DESCRIPTION OF VARIOUS EMBODIMENTS

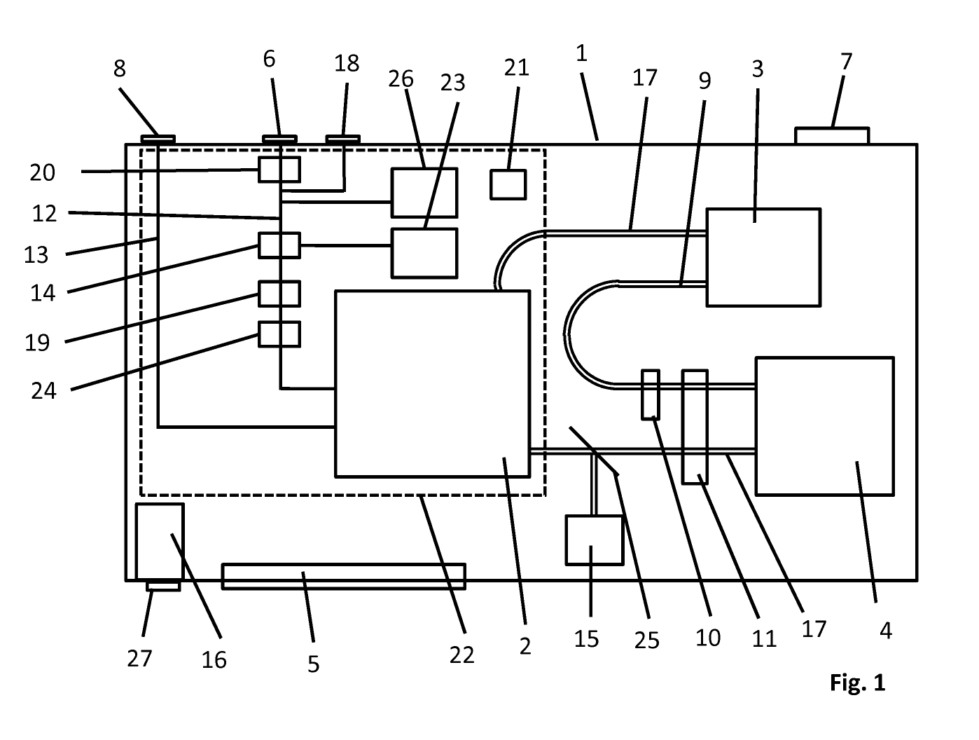

FIG. 1 shows in schematic form a view of an exemplary embodiment of the inventive apparatus for inline trace analysis of a fluid. The apparatus comprises a housing 1, in order to allow safe and easy handling of the apparatus as an inline measuring device in various fields of industry. In this context one application is the semiconductor industry, where the apparatus can be used to monitor and analyze aqueous process solutions in real time and continuously.

The apparatus comprises a microchannel 2, which is etched as a spiral-shaped optical waveguide in a silicon wafer. In this case the microchannel 2 is shown only in schematic form by means of the component marked with the reference numeral 2. Such a microchannel with respective supply and coupling-in elements for fluid and light is described in detail in EP 2 486 388 B1.

On the one hand, the fluid to be analyzed is passed through the microchannel 2; and, on the other hand, the light from a light source 3 is coupled in. The light emerging from the microchannel 2 is analyzed with a detector 4. The detector 4 can be designed for a variety of spectrometric analyses. For example, the detector 4 may be designed for measuring the extinction.

In order to monitor and operate the apparatus and the components arranged therein, a user interface 5 is integrated into the housing 1. This user interface can be implemented, for example, by means of a display or touch panel.

All of the aforementioned components of the apparatus are arranged in the housing 1 or are integrated into the housing 1. In order to feed the fluid into the microchannel 2, the housing 1 has a port 6, through which the fluid to be analyzed can be fed continuously into the housing 1. The power supply of the apparatus is provided by way of a terminal 7. Suitable power supply units may be arranged in the housing 1.

In addition to the port 6 for supplying the fluid, the housing 1 also has a port 8 for discharging the fluid from the microchannel 2. As a result, a continuous flow mode with respect to the fluid to be analyzed is ensured with the apparatus.

Furthermore, the apparatus has at least one port 18 for supplying a flushing solution. Therefore, a suitable flushing solution can flow from time to time through the fluid circuit, in particular, the microchannel 2 and, in so doing, can clean it. It is also possible to use a plurality of ports 18 for different flushing solutions, such as, for example, an acid and an alkaline flushing solution.

With respect to a reliable measurement and a measurement result of high quality, the apparatus comprises a reference channel 9, which is formed virtually parallel to the measurement channel 17 that runs through the microchannel 2. In the specific case the reference channel 9 is formed by a rolled up optical waveguide that extends from the light source 3 as far as to the detector 4.

In order to match the signal strength of the signal, which is in essence unattenuated by the reference channel 9, with the measurement signal passing through the microchannel 2, the reference channel 9 is assigned an attenuator 10. The attenuator 10 attenuates the signal in the reference channel 9, before said signal reaches the detector 4.

Furthermore, upstream of the detector 4 a switch-over device 11 is implemented in the form of, for example, a shutter, so that only the light from one channel—either from the measurement channel 17 or from the reference channel 9—is guided to the detector 4. Such a data acquisition from just one channel simplifies the construction of the detector 4, for example, as merely a line detector.

In order to prevent damage, for example, when a predetermined pressure level is exceeded or when the fluid leaks, the apparatus can have safety valves 20, arranged in a suitable manner. For example, a supply line 12 for supplying and/or a discharge line 13 for discharging the fluid and/or the microchannel 2 may be assigned a safety valve 20, which responds when a predetermined pressure level is exceeded or when there is a leak. The triggering of such a safety valve could result in an alarm signal being transmitted to a suitable alarm device.

In order to detect an undesired leakage of a fluid from a line in the housing 1 or from the microchannel 2, the housing 1 can be assigned a humidity sensor or leak sensor 21. Such a humidity sensor or leak sensor 21 could be arranged in a drip tray 22 for fluids; and this drip tray may be located, for example, below the microchannel 2 or even at a suitable point below a fluid-conveying supply line 12 or discharge line 13. In a particularly advantageous embodiment the drip tray 22 covers the entire fluid-conveying area inside the housing 1, so that the leakage of fluid at any point is detected by the humidity or leak sensor 21. Such a humidity sensor or leak sensor 21 may be assigned a switch-off device for the apparatus and/or a pump 19 or a piezoelectric diaphragm pump. In this way the objective of a safety cut-out in the event of a fluid leakage can be fulfilled. In addition, the safety valves 20 are actuated by the signal of the humidity or leak sensor 21, so that the supply of fluid into the housing 1 is stopped.

Furthermore, the exemplary embodiment of the apparatus has a degassing device 14 with a vacuum pump 23, in order to remove air bubbles and dissolved gases inside the fluid. In the exemplary embodiment shown in this case, the degassing device 14 is assigned to the supply line 12.

In order to regulate a flow rate of a fluid and/or an analyte and/or a complexing agent, it is possible to provide a flow measuring device 24, which can be assigned to a supply line 12 and/or to a discharge line 13 or to the microchannel 2.

Furthermore, the apparatus, shown in FIG. 1, includes a UV irradiation device 15 for radiating the ultraviolet light into the microchannel 2, in order to kill the bacteria or germs cultivated in the microchannel 2. To this end, the UV rays can be radiated in an advantageous manner by way of a semi-transparent mirror 25 through the microchannel 2 counter to the direction of measurement away from the detector 4, in order to dislodge oxygen micro-bubbles from the inner wall of the microchannel 2 and in order to fulfill the objective of killing the germs or bacteria. The UV light source 15 consists of, for example, a xenon flash tube.

The apparatus contains an additional UV light source 26, such as, for example, a cold cathode tube. The ultraviolet light of this UV light source 26 is coupled in directly downstream of the safety valve 20, in order to fulfill the objective of killing the bacteria and germs in the system as soon as possible. The UV radiation can have, for example, a wavelength of 254 nm. This is a wavelength that is particularly effective with respect to killing germs.

Furthermore, a computer 16 is disposed in the housing 1; and this computer carries out the entire control of the apparatus and/or evaluation of the measurement results. The computer has an interface 27, by way of which the apparatus can be connected to a network.

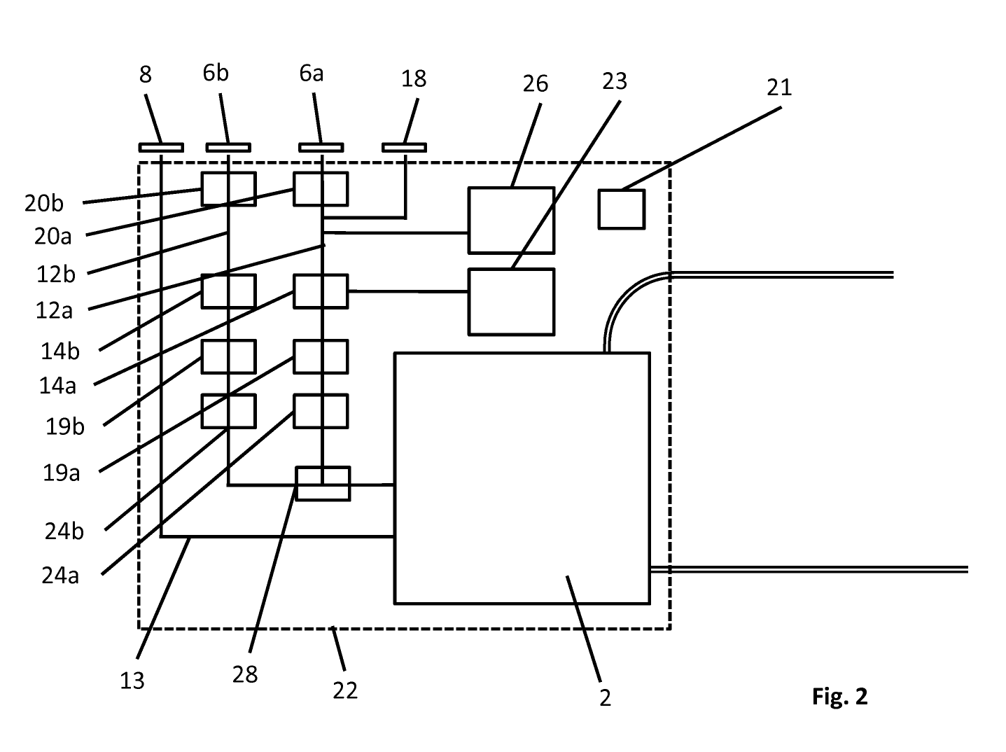

FIG. 2 shows details of a subarea of the inventive apparatus for inline trace analysis of a fluid. The supply line and some or all of the components therein are divided into two branches. The analyte, that is, the fluid that contains the substances to be analyzed, is fed into branch 6a of the supply line. The complexing agent, which enters into a reaction with the analyte, is fed into the branch 6b of the supply line, as a result of which the more readily detectable complexes are formed. For clarification purposes: the reference numerals in FIG. 2 correspond to those in FIG. 1 with the addition of the branch identifiers a or b. The two fluids are combined in a mixer 28. In this case the mixer 28 may be a structured component, where efficient and thorough mixing takes place. In a particularly simple manner, the mixer 28 is just a coupling point, where the two fluids meet.

With respect to other advantageous embodiments of the apparatus in accordance with the invention, reference is made to the general part of the description and the appended claims. For example, it has been found in accordance with the invention that it is possible to arrange the components, which are relevant for the apparatus to work, in a housing in such a way that a particularly easy handling of the apparatus, in particular, as an inline measuring device or as a portable measuring device, is made possible in a structurally simple way. In the specific case both the microchannel and the detector are arranged in a housing or are integrated into the housing. In this respect the housing has in further accordance with the invention a port for feeding the fluid to be analyzed into the microchannel. Furthermore, for a reliable supply of power to the apparatus, the housing has a terminal to supply power to the apparatus. Furthermore, with respect to the easy handling of the apparatus as an inline measuring device, this objective is fulfilled with a user interface, which is arranged in the housing or is integrated into the housing. This user interface is used to monitor and/or operate the apparatus.

Consequently the inventive apparatus permits easy handling as an inline measuring instrument with structurally simple means.

With respect to particularly easy handling of the apparatus, the light source may be disposed in the housing. In this case a separate supply of light from outside the housing into the microchannel is not required. As an alternative and with respect to a particularly high flexibility of the light source that is used, the housing may comprise a port for feeding the light of the light source into the microchannel. Such a port allows the flexible use of different light sources, and the selected light source has only to be coupled to the port from outside the housing. Various types may be considered as the light sources. An LED light source, which is associated with a long life and a low thermal output, can be used in a particularly practical way. In this context an LED light source also lends itself quite well to being built into the housing without having to be concerned about the function of the apparatus being degraded by a high thermal output. Another advantage of an LED light source is that the spectral distribution of light can be controlled to some extent. As a result, the spectrum that is used can be adjusted to the substance to be analyzed. However, it is also possible to use, depending on the application, halogen light sources, tunable laser light sources or other light sources.

With respect to a particularly high throughput or continuous measurement of a fluid to be analyzed, the housing may include a port to discharge the fluid from the microchannel. With such an embodiment it is not only possible to feed the fluid to be analyzed into the housing and, thus, from the outside into the microchannel, but also, after an analysis, to discharge said fluid from the housing. In an alternative embodiment a collecting container for fluid emerging from the microchannel may be disposed in the housing. In this case the fluid to be analyzed is passed, after the analysis, into the collecting container, which can be emptied in a suitable way on reaching a specifiable filling level. In an alternative embodiment the collecting container may be arranged in the housing in a manner allowing removal, so that it can be taken out of the housing in order to empty said collecting container. Furthermore, this type of removability also allows the collecting container to be easily cleaned in the removed state.

With respect to ensuring a particularly reliable analysis and measurement with the apparatus in accordance with the invention, this objective may be fulfilled with a reference channel, which may be provided, for example, in the form of an optical waveguide, which can extend virtually parallel to the microchannel. Then in one measurement method a reference spectrum, on the one hand, and a measured spectrum, on the other hand, can be compared with each other, in order to fulfill the objective of a reliable measurement result. In order to match the light intensities of the measurement channel with the reference channel, the reference channel can be assigned an attenuator.

Furthermore, if there is a reference channel, then the reference channel may be assigned a switch-over device for the light, so that either the light, passed through the microchannel, or the light, passed through the reference channel, can be measured in the detector. The switch-over device could be implemented as a stopper or shutter. Furthermore, the switch-over device can be arranged, for example, directly in front of a spectrometer or detector. The switch-over device permits a simple embodiment of the detector in the form of, for example, a line detector, since in all cases only light from one channel is to be detected. For an optionally necessary dark adjustment of the detector, the switch-over device can switch off both the measurement channel and the reference channel, so that no light falls on the detector. As a result, the dark current of the detector can be determined; and the dark adjustment can be carried out. In other words, in order to measure the dark field, both the light, passed through the microchannel, and the light, passed through the reference channel, can be blocked off from the detector or in front of the detector.

The apparatus of the invention is used to detect minute traces of substances in a fluid. Frequently the substance to be detected cannot be detected directly, but rather only after completion of a detection reaction. For this purpose a complexing agent is added to the fluid to be analyzed, i.e. the analyte; and this complexing agent triggers the detection reaction. The analyte and the complexing agent may be combined in a mixer. In this case the mixer may be a structured component, where an efficient and thorough mixing takes place. In a particularly simple manner, the mixer is simply a coupling point, where the two fluids meet. The product of the detection reaction can be identified, for example, by means of an absorption measurement. With respect to a particularly safe handling of the apparatus and to carrying out the measurement, it is possible to use safety valves that ensure the necessary safety in operating and handling the apparatus when feeding in the fluid, the analyte or a complexing agent. When the apparatus is in operating states that are inadmissible or undesired, the safety valves can be used to suppress the supply and/or the discharge of the fluid and/or an analyte and/or a complexing agent. Inadmissible or undesired operating states of the apparatus may be, for example, exceeding a specifiable pressure level, the failure of systemically relevant components or the escape of fluids, i.e., leakage. Furthermore, the safety valves can prevent the fluids from flowing back into the higher level system.

In the specific case, in a preferred embodiment of the apparatus a supply line for supplying and/or a discharge line for discharging the fluid and/or an analyte and/or a complexing agent and/or the microchannel may be assigned a safety valve when a specifiable pressure level is exceeded in the supply line, the discharge line or the microchannel. In the final end, a safety valve may be used in all cases where a fluid, an analyte or a complexing is supplied or discharged.

Furthermore, with respect to a particularly high level of safety when the apparatus is running, a humidity sensor or leak sensor can be disposed in the housing. Such a sensor can respond to an unwanted leakage of fluid and can provide a suitable signal and, if desired, transmit said signal to an alarm device. For example, a humidity sensor or leak sensor may be disposed in a drip tray for fluids, and said drip tray can be disposed at a suitable point in the housing, preferably below supply lines or discharge lines or below the microchannel.

The signal of the humidity or leak sensor can be used to actuate the safety valves and to suppress the supply and/or to discharge the fluid and/or the analyte and/or the complexing agent. In a further advantageous manner the humidity sensor or the leak sensor may be assigned a switch-off device for the apparatus and/or a pump or a piezoelectric diaphragm pump. Such pumps or piezoelectric diaphragm pumps can be used for conveying the fluid, the analyte or a complexing agent in a suitable way.

For a reliable operation of the apparatus and for a reliable measurement it is important to ensure that there are no air bubbles in the supply lines or in the microchannel or that no bubbles are generated in the supply lines or in the microchannel. For this purpose a supply line for supplying the fluid and/or an analyte and/or a complexing agent and/or the microchannel may be assigned a degassing device. Such a degassing device may have, for example, a semi-permeable diaphragm and a vacuum pump. In this case not only air bubbles, but also gases, such as oxygen, which are dissolved, for example, in the fluid, have to be removed as much as possible, in order to ensure a reliable measurement.

With respect to a reliable supply of fluid and/or a reliable passage of the fluid, an analyte or a complexing agent, a supply line for supplying and/or a discharge line for discharging the fluid and/or an analyte and/or a complexing agent and/or the microchannel can be assigned a flow measuring device. Such a flow measuring device can be used preferably for open or closed loop control of a flow rate. In this respect the flow measuring device can be coupled with suitable pumps, in order to influence the flow rate. As a result, in particular, the flow rate of an analyte and/or a complexing agent can be specified precisely; and suitable mixing ratios can be carried out exactly.

In order to supply or convey liquid components reliably, a supply line for supplying and/or a discharge line for discharging the fluid and/or an analyte and/or a complexing agent and/or the micro channel can be assigned a suitable pump, in particular, a piezoelectric diaphragm pump. In this way a reliable guide of the necessary and suitable liquid components in the apparatus is ensured.

With respect to operating the apparatus reliably and easily, the apparatus may have a flushing device for a supply line for supplying and/or a discharge line for discharging the fluid and/or an analyte and/or a complexing agent and/or for the microchannel. In particular, after a long continuous inline operation of the apparatus, it may be necessary to flush the fluid lines of the apparatus. This objective can be fulfilled in a simple manner by means of such a flushing device.

With respect to a reliable operation of the apparatus and a possible multi-channel design, the fluid-carrying components, i.e., the supply lines, the discharge lines, the pumps, the safety valves, the degassing devices, the microchannel, etc., can be mounted on a drip tray. The drip tray is designed to catch the fluid in case of leaks and to feed said fluids to a humidity or leak sensor. Mounting all of the components on the drip tray allows this unit, also called the fluidic module, to be easily swapped. One special advantage of the modular design is that several units can be installed in one housing, so that a multi-channel system is formed, in which a plurality of different fluids can be analyzed. For this purpose the optical components have multiple inputs and outputs, so that they can be used for multiple measurement channels.

In a particularly advantageous embodiment, only the switch-over device is equipped with more than two channels, for example, with four channels, of which one is used for the reference channel, while the other three are available for measurement channels. For a multi-channel embodiment only the fluidic module has to be arranged in duplicate, triplicate, or a plurality of times, while the spectrometer and the light source are present just once.

In order to ensure the total reflection, required for the measurements to be carried out, in the microchannel, the microchannel typically has a coating made of a suitable plastic, for example, Teflon®. However, this plastic coating is conducive to the growth of harmful bacteria and germs in the microchannel, so that the quality of the measurement is significantly affected. In addition to germ growth, an accumulation of gas bubbles, in particular, oxygen bubbles, in the microchannel leads to a degradation of the measurement. To kill or eliminate these bacteria and germs and to prevent gas bubbles, the microchannel can be assigned a UV irradiation device to radiate the ultraviolet light into the microchannel. In order to prevent the ultraviolet light from entering into the detector, which is downstream of the microchannel, and from affecting the measurement, the ultraviolet light can be radiated counter to the direction of measurement through the microchannel away from the detector. With respect to killing the bacteria and germs in a particularly reliable way, the UV irradiation device may be designed in such a way that it is possible to radiate the ultraviolet light into both ends of the microchannel. In this way the ultraviolet light can enter the microchannel from two sides in a reliable way. At this point a particularly effective light source for the ultraviolet light is a xenon flash tube. Since the flash tube is operated in pulsed mode, the total radiation power can be specifically adapted to kill bacteria and germs and/or to prevent gas bubbles. Owing to the pulsed operation the power loss, i.e., the waste heat, is reduced just as well in the housing. An additional advantage of the pulsed operation is the resulting possible synchronization with the detector, so that any effect on the measurement, for example, by stray light is further reduced.

An additional UV light source to kill bacteria and germs can be mounted in front of the microchannel. It is particularly advantageous to mount it on the foremost point of the apparatus, in order to prevent the growth of bacteria and germs as soon as possible or to kill already existing bacteria and germs or those that have been flushed in. The UV light source can be arranged directly behind the safety valve.

Instead of an irradiation by ultraviolet light, the pH of the fluids (the analyte or the complexing agent) flowing through the apparatus could also be adapted, so that the growth of germs is prevented, or already existing bacteria and germs are killed. The pH value may be adjusted in such a way that an acidic environment is generated, for example, with a pH=2. However, an alkaline, i.e., basic, environment would also be conceivable. Especially advantageous is the adjustment of the pH by way of the complexing agent.

With respect to a reliable and easy operation of the apparatus, a computer can be disposed in the housing, and said computer is designed preferably as a PC. With such a computer the entire apparatus can be controlled. In addition, an evaluation of the measurement results can be carried out with the computer. The computer can be implemented in an advantageous manner as a so-called “embedded” computer with a suitable interface, in order to allow, for example, integration into a network.

Also with respect to a particularly safe and easy handling of the apparatus, the housing may be designed in such a way that it can be arranged in a frame, preferably in a 19 inch frame. Such frames permit a secure arrangement of the housing when operating the apparatus and, as a result, good accessibility for an operator.

The inventive apparatus for inline trace analysis of a fluid fulfills the objective of a compact inline measuring unit that can be used in a particularly advantageous manner for a wide range of analytic applications. In such an analysis flow rates of a few μ1/min. through the microchannel are typical.

Furthermore, the apparatus in accordance with the invention fulfills the objective of an automated analyzing device for the continuous detection of, for example, metal ions in a sub ppb range. Impurities in very low concentrations in aqueous solutions can be detected spectrometrically by means of a preferably spiral-shaped microchannel having a large length of several meters. In this case the light is coupled into a channel, through which the analyte has been flushed, and is guided over as long a path as possible owing to total reflection, in order to achieve a measurable extinction even at very low ion concentrations.

Last, but not least, it is expressly to be noted that the above described exemplary embodiment of the apparatus of the invention serves only to explain the claimed teaching, but does not limit said teaching to the exemplary embodiment.

### LIST OF REFERENCE NUMERALS AND CHARACTERS

1 housing
2 microchannel
3 light source
4 detector
5 user interface
6 port fluid
6a branch
6b branch
7 terminal power supply
8 port discharge
9 reference channel
10 attenuator
11 switch-over device
12, 12a, 12b supply line
13 discharge line
14, 14a, 14b degassing device
15 UV irradiation device
16 computer
17 measurement channel
18 flushing port
19, 19a, 19b pump
20, 20a, 20b safety valve
21 humidity or leak sensor
22 drip tray
23 vacuum pump
24, 24a, 24b flow sensor
25 semi-transparent mirror
26 UV light source
27 interface
28 mixer

1-15. (canceled)

16. Apparatus for inline trace analysis of a fluid, said apparatus comprising:
a housing (1);
a microchannel (2), through which the fluid to be analyzed is allowed to flow and into which light of a light source (3) is coupled;
a detector (4) for light emerging from the microchannel (2); and
a user interface (5) for at least one of monitoring or operating the apparatus,
wherein:
at least one of the microchannel (2), the detector (4) or the user interface (5) is at least one of arranged in or integrated into the housing (1), and
the housing (1) has a port (6) for feeding the fluid into the microchannel (2) and a terminal (7) for supplying power to the apparatus.

17. Apparatus, as claimed in claim 16, wherein either:
the light source (3) is arranged in the housing (1), or
the housing (1) has a port for feeding the light of the light source (3) into the microchannel (2).

18. Apparatus, as claimed in claim 16, wherein either:
the housing (1) has a port (8) for discharging the fluid from the microchannel (2), or
a collecting container for fluid emerging from the microchannel (2) is arranged in the housing (1).

19. Apparatus, as claimed in claim 16, wherein a reference channel (9) is implemented.

20. Apparatus, as claimed in claim 19, wherein the reference channel (9) is assigned a switch-over device (11) for the light, so that either the light passed through the microchannel (2) or the light passed through the reference channel (9) can be measured in the detector (4).

21. Apparatus, as claimed in claim 19, wherein the reference channel (9) is assigned a switch-over device (11) for the light, so that in order to measure the dark field, the light passed through the microchannel (2) and the light passed through the reference channel (9) are both blocked off from the detector (4).

22. Apparatus, as claimed in claim 16, wherein:
a safety valve is assigned to at least one of:
a supply line (12) for supplying at least one of the fluid, an analyte, or a complexing agent,
a discharge line (13) for discharging at least one of the fluid, the analyte, or the complexing agent, or
the microchannel (2), and
the safety valve is configured to respond on exceeding a specifiable pressure in the supply line (12), in the discharge line (13), or in the microchannel (2).

23. Apparatus, as claimed in claim 16, wherein either a humidity sensor or a leak sensor is arranged in the housing (1).

24. Apparatus, as claimed in claim 16, wherein a degassing device (14) is assigned to at least one of:
a supply line (12) for supplying at least one of the fluid, an analyte, or a complexing agent, or
the microchannel (2).

25. Apparatus, as claimed in claim 16, wherein a flow measuring device is assigned to at least one of:
a supply line (12) for supplying at least one of the fluid, an analyte, or a complexing agent,
a discharge line (13) for discharging at least one of the fluid, an analyte, or a complexing agent, or
the microchannel (2).

26. Apparatus, as claimed in claim 16, wherein a piezoelectric diaphragm pump is assigned to at least one of:
a supply line (12) for supplying at least one of the fluid, an analyte, or a complexing agent,
a discharge line (13) for discharging at least one of the fluid, an analyte, or a complexing agent, or
the microchannel (2).

27. Apparatus, as claimed in claim 16, wherein the apparatus comprises a flushing device for at least one of:
a supply line (12) for supplying at least one of the fluid, an analyte, or a complexing agent,
a discharge line (13) for discharging at least one of the fluid, an analyte, or a complexing agent, or
the microchannel (2).

28. Apparatus, as claimed in claim 16, wherein the microchannel (2) is assigned a UV irradiation device (15) for radiating UV light into the microchannel (2).

29. Apparatus, as claimed in claim 16, wherein a computer (16) is arranged in the housing (1).

30. Apparatus, as claimed in claim 16, wherein the housing (1) is arranged in a frame.

31. Apparatus, as claimed in claim 16, wherein the fluid is an aqueous process solution.

32. Apparatus, as claimed in claim 17, wherein the light source is an LED light source.

33. Apparatus, as claimed in claim 19, wherein the reference channel (9) is an optical waveguide and is assigned an attenuator (10).

34. Apparatus, as claimed in claim 23, wherein the humidity sensor or the leak sensor is arranged in a drip tray for fluids.

35. Apparatus, as claimed in claim 23, wherein the humidity sensor or the leak sensor is assigned a switch-off device for at least one of the apparatus, a pump, or a piezoelectric diaphragm pump.

36. Apparatus, as claimed in claim 24, wherein the degassing device (14) is a vacuum pump.

37. Apparatus, as claimed in claim 25, wherein the flow measuring device is configured for either open or closed loop control of a flow rate of at least one of the analyte or the complexing agent.

38. Apparatus, as claimed in claim 28, wherein the UV irradiation device (15) is configured for radiating the UV light into both ends of the microchannel (2).

39. Apparatus, as claimed in claim 30, wherein the frame is a 19 inch frame.
